(19) United States
(12) Patent Application Publication
(10) Pub. No.: US 2010/0077403 A1
(43) Pub. Date: Mar. 25, 2010

(54) Middleware for Fine-Grained Near Real-Time Applications

(76) Inventors: Chaowei Yang, Gaithersburg, MD (US); Bin Zhou, Fairfax, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/565,353

(22) Filed: Sep. 23, 2009

Related U.S. Application Data
(60) Provisional application No. 61/099,374, filed on Sep. 23, 2008.

(51) Int. Cl. G06F 9/46

(52) U.S. Cl. 718/104

(57) ABSTRACT

A centralized scheduling server for scheduling fine-grained near real-time applications includes network ports, a central managing application, functional library(ies) and service processes. One port communicates with processing nodes over a private computer network. Processing nodes include processing node report processor node status to the server and execute scheduled tasks. The other port communicates with user devices through a public network. The central managing application manages fine-grained near real-time application. The functional library provides middleware core functionality. The service processes include: a resource manager, a submitter to place tasks on a task queue; and a dispatcher to dispatch tasks to processing nodes. A work flow process runs an optimized scheduling algorithm.

### CROSS-REFERENCE TO RELATED APPLICATIONS

This application claims the benefit of U.S. Provisional Application No. 61/099,374, filed Sep. 23, 2008, entitled “Middleware for Fine-Grained Near Real-Time Geospatial Applications,” which is hereby incorporated by reference in its entirety.

### STATEMENT REGARDING FEDERALLY SPONSORED RESEARCH OR DEVELOPMENT

This invention was made with government support under Grant Number NNX07AD99G awarded by NASA and Grant Number 08HQAG0015 awarded by the United States Geological Survey. The government has certain rights in the invention.

### REFERENCE TO COMPUTER PROGRAM LISTING APPENDIX

A portion of the present disclosure is contained in a computer program listing appendix filed electronically herewith as an ASCII text file, which is hereby incorporated by reference in its entirety. The ASCII text file is entitled Listing.txt created on May 17, 2008, of approximately 18 kilobytes.

### BACKGROUND

The emergence and flourishing of near real-time applications is increasingly demanding the Cyberinfrastructure (CI) to handle large amounts of concurrent processing requests within a limited time interval. For example, rapid response to emergencies, such as the 2007 California fire and traffic accident congestion, required computing conducted for and results disseminated to thousands of concurrent users within seconds or minutes. (See Q Yang, HN Koutsopoulos, “A microscopic traffic simulator for evaluation of dynamic traffic management systems,” Transportation Research Part C: Emerging Technologies, Vol. 4:113-129, June 1996). Distinguished from hard real-time requirements, these applications are required to be executed by an expected deadline. While no hard deadline is actually set and no time penalty is related to missing the deadline, these applications may tolerate a distribution of delays in seconds or minutes which are usually associated with specific applications.

Most rapid responses to emergencies require the processing of geospatial information in a timely manner. The demand for near real-time processing and responses to large amounts of concurrent users is typical. For example, a) to predict the atmospheric transport of hazardous materials and provide rapid response data, relevant geospatial information, such as terrain type and travel routes may be considered in order to generate a GIS map of the affected public areas; b) to cope with real-time disasters, a decision support system may integrate geospatial information to provide mitigation and escape route information in near real-time; c) other systems, such as traveler information systems and highway transportation planning systems, may require efficient information retrieval and processing on a near real-time basis. Many other GIS applications, such as hydrographic surveys and near real-time flood management may also have near real-time requirements. The geospatial applications with near real-time requirements pose computing challenges for popular geographic information systems. Geospatial information may need to be processed in near real-time while at the same time satisfying thousands of concurrent users with different computing requirements. Within such systems, data modeling, processing and representation may all require a significant amount of computing power. Near real-time geospatial applications may include one or more of the following characteristics: a) processing geospatial information in near real-time, b) communicating relatively small amounts of geospatial information, and c) accessibility by large amounts of concurrent users. Applications with such characteristics are termed Fine-grained Near Real-time (FiNeR) applications.

What is needed is a near-optimal approach to meet the computing challenges of near real-time applications in a grid computing environment.

### BRIEF DESCRIPTION OF THE SEVERAL VIEWS OF THE DRAWINGS

FIG. 1 shows pseudo-code for an example of Lawler's Algorithm.

FIG. 2 shows pseudo-code for an example of a revised Lawler's Algorithm as per an aspect(s) of an embodiment of the present invention.

FIG. 3 is a table showing task major characteristics as per an aspect(s) of an embodiment of the present invention.

FIG. 4 is a table showing a task executing time matrix on different machines as per an aspect(s) of an embodiment of the present invention.

FIG. 5 depicts a simulated example of scheduling of eight tasks on a 4-core system using an extended algorithm as per an aspect(s) of an embodiment of the present invention.

FIG. 6 is a diagram that depicts a layer structure that may be used for a system architecture as per an aspect(s) of an embodiment of the present invention.

FIG. 7 is a diagram that illustrates system functionalities and workflow as per an aspect(s) of an embodiment of the present invention.

FIG. 8 is a diagram that illustrates a task life cycle as per an aspect(s) of an embodiment of the present invention.

FIG. 9 is a diagram of test environment for a prototype embodiment that includes eight servers and several desktops configured as per an aspect(s) of an embodiment of the present invention.

FIG. 10 is a table of test environment parameters and task parameters from a test of a prototype embodiment configured as per an aspect(s) of an embodiment of the present invention.

FIG. 11 is a graph showing the effect of task amount on TFT in a test of a prototype embodiment configured as per an aspect(s) of an embodiment of the present invention.

FIG. 12 is a graph showing the effect of task amount on ART in a test of a prototype embodiment configured as per an aspect(s) of an embodiment of the present invention.

FIG. 13 is a graph showing the effect of different CPU numbers and task amounts in a test of a prototype embodiment configured as per an aspect(s) of an embodiment of the present invention.

FIG. 14 is a table showing curve fitting results from a test of a prototype embodiment configured as per an aspect(s) of an embodiment of the present invention.

FIG. 15 is a graph showing the effect of task length in a test of a prototype embodiment configured as per an aspect(s) of an embodiment of the present invention.

FIG. 16 is a graph showing the effect of available CPUs in a test of a prototype embodiment configured as per an aspect(s) of an embodiment of the present invention.

FIG. 17 is a table showing test area characteristics from a test of a prototype embodiment configured as per an aspect(s) of an embodiment of the present invention.

FIG. 18 is a graph showing the effect of different CPU numbers and task amounts in a test of a prototype embodiment configured as per an aspect(s) of an embodiment of the present invention.

FIG. 19 is a graph showing the average response time to task amount for 16 CPUs in a test of a prototype embodiment configured as per an aspect(s) of an embodiment of the present invention.

FIG. 20 is a block diagram of a system for scheduling fine-grained near real-time applications as per an aspect(s) of an embodiment of the present invention.

FIG. 21 is a block diagram of a centralized hardware scheduling server as per an aspect(s) of an embodiment of the present invention.

FIG. 22 is a flow diagram of a scheduling process performed by a centralized hardware scheduling server as per an aspect(s) of an embodiment of the present invention.

### DETAILED DESCRIPTION OF EMBODIMENTS

The utilization of geospatial information system for emergency response applications pose a challenge to leverage the distributed computing resources for dealing with fine-grained, near real-time applications with massive concurrent requirements. Embodiments of the present invention disclose a middleware and relevant scheduling for such geospatial applications within a grid computing environment. Some embodiments utilize an extended Lawler's algorithm to schedule fine-grained tasks using a light-weighted middleware for near real-time geospatial applications.

A potential solution for meeting the computing challenges of near real-time applications is to acquire high-performance computers but at high prices. On the other hand, embodiments of the present invention leverage the CI to meet near real-time requirements with grid-computing technology. The grid-computing technology may be used with middleware to coordinate resources within a CI efficiently by maintaining low overhead and short delays achieved by formulaic scheduling.

Scheduling is the assignment of tasks to computing resources according to specific criteria and algorithms. The criteria and algorithms may be chosen based on the characteristics of the applications. The difficulty lies in which solution is feasible for a particular case and how to implement it in a way that may significantly improve performance. Embodiments of the present invention enable a near-optimal approach to meet the computing challenges of near real-time applications in a grid computing environment. By extending the traditional periodic task model for a heterogeneous multi-machine environment, a middleware is implemented as a high level scheduling strategy based on a low level TCP/IP communication library. Embodiments of the middleware are configured to achieve a polynomial overhead which guarantees the task timing constraints and deadlines.

The currently disclosed embodiments address computing challenges of scheduling resources for computing requirements. To target near real-time applications, the problem were addressed systematically from three aspects: 1) algorithms that can efficiently schedule resources, 2) software/middleware that implement the scheduling algorithms, and 3) application solutions that utilize the scheduling algorithms and middleware.

Scheduling Algorithms will now be discussed. Traditional scheduling problems, such as the shop scheduling problem, batching problem, and parallel machine problem, have been studied intensively. A variety of optimality criteria and side constraints were also analyzed and scheduling policies were introduced for different conditions.

Among the algorithms, the shop scheduling problem is mainly for the distributed and Grid computing environments, but it is a Nondeterministic Polynomial-time hard (NP-hard) problem. Approximation algorithms and near-optimal algorithms were studied for practical use. The similar master-slave task scheduling problem was investigated for independent tasks. Based on these research investigations, a near-optimal approach for achieving a smaller scheduling overhead was chosen. In and out forests scheduling was also well studied and it was determined that it may be expanded to achieve an elegant polynomial solution. Taking into consideration the communication delay and task dependency, the polynomial solution, Lawler's algorithm was considered, which is good for simple tree-dependency tasks. However, this algorithm was extended for near real-time applications.

Because of the rapid expansion of grid computing, opportunistic scheduling may be utilized. By utilizing idle CPU cycles, an opportunistic scheduler may achieve high-throughput in time-varying computing conditions. Some traditional scheduling algorithms may be transformed to opportunistic schedulers as described later.

Scheduling Middleware will now be discussed. Scheduling algorithms, such as round robin and first-come-first-serve (FCFS) may be extended with opportunistic methods to support large distributed systems to enable virtual organization collaborations. Load Sharing Facility (LSF)[Error! Reference source not found.], Portable Batch System (PBS) [Error! Reference source not found.], and Condor [Error! Reference source not found.] are the primary exemplar opportunistic scheduling middleware for grid computing. (See S. Zhou, X. Zheng, J. Wang and P. Delisle. “U topia: A Load Sharing Facility for Large, Heterogeneous Distributed Computer Systems,” Software, Practice and Experience, Vol. 23(1212):1305-1336, 1993; R. L. Henderson. “Job Scheduling Under the Portable Batch System,” in Proceedings of Workshop on Job Scheduling Strategies for Parallel Processing, Santa Barbara, Calif., USA, Lecture Notes In Computer Science, 949, Springer: London, 1995, pp. 279−294; and M. J. Litzkow, M. Livny, and M. W. Mutka. “Condor-A Hunter of Idle Workstations,” in Proceedings of 8th International Conference on Distributed Computing Systems, San Jose, Calif., USA, 1988, pp. 104-111).

LSF is widely used by the world's most powerful supercomputers. It uses priority scheduling, backfill scheduling, deadline scheduling, and other algorithms to support the sequential and parallel applications in both interactive and batch modes by integrating the loosely coupled heterogeneous clusters into a unified platform.

PBS is particularly designed for batch jobs in a heterogeneous platform using basic scheduling policies, such as FCFS and Round Robin. PBS also offers more advanced scheduling policies like load balance and a priority-based queue, and supports a user-defined scheduling interface to customize policy.

Condor is focused on high throughput computing. It utilizes the idle CPU cycles of desktops and servers to save wasted computing power. The up-down strategy may be implemented to balance loads between the computing nodes and fairness between users. The match-making allocation method may be used to find resources. The FCFS with priority queuing approach is applied among the same user's tasks. It may be improved with more scheduling policies added.

Many scheduling middleware have configurations to improve scheduling timeliness but there is no mutual real-time scheduling middleware for cluster computing. The real-time systems scheduling problems are studied for single-processor or static multi-processor systems, where the timing constraints were considered as a hard or soft deadline and the machine environment was considered static. Nevertheless, the distributed scheduling system, which can achieve near real-time performance, is seldom proposed. There is no middleware that can satisfy near real-time requirements very well across a distributed environment, which motivated the need for a new FiNeR scheduling solution.

Near Real-time Applicability of Scheduling Algorithms and Middleware will now be discussed. A primary goal of grid computing is to maximize throughput and add more user functionality. Previous research into scheduling problems in grid computing environments was focused on coarse-grained applications. Usually, the applications dealt with are computing intensive tasks, such as earthquake visualization or neuroscience simulation, which have long execution times (hours, days, or even months), while response times and deadline restrictions are not concerns. Relevant research has been focused on how to best schedule batch jobs. Task rotation and round-robin algorithms were introduced to improve response time for small tasks. However, the small tasks defined here are of mean demand length of around 100-500 minutes and the context switch overhead is 6-30 seconds, which are plausible numbers but much bigger than a near real-time applications' time restrictions. When dealing with FiNeR applications in a Grid computing environment, the performance of these schedulers is not satisfactory. Embodiments of the present invention may improve the response time while maintaining high throughput and affordable efficiency, using a proper scheduling algorithm and middleware.

In order to deal with the near real-time scheduling problem by minimizing the average response time for a given number of requests and computing infrastructure, embodiments of the present invention focus on the scheduler and middleware for FiNeR applications. In this disclosure: a description is formalized; an approach is detailed; a middleware embodiment of the present invention is evaluated against Condor through systematic tests; and various task lengths and CPU number tested to find the optimized configuration to achieve the best performance is discussed. A near real-time routing example is used to illustrate the applicability of middleware embodiments for near real-time applications.

The Fine-grained near real-time (FiNeR) scheduling problem will now be discussed. The popular scheduling problem notation defined by Graham, Lawler will be used. (See, R. L. Graham, E. L. Lawler, J. K. Lenstra, and A. H. G. Rinnooy Kan. “Optimization and Approximation in Deterministic Sequencing and Scheduling: A Survey,” Annals of Discrete Mathematics, Vol. 5:287-326, 1979). A scheduling problem is denoted by α|β|γ, where α denotes the machine environment, β denotes the task characteristics, and γ denotes the optimality criteria. A schedule is an allocation of the tasks to be executed at a particular moment on a particular machine environment.

Assumptions and Definitions will now be discussed. FiNeR tasks are common in different geospatial applications that have different requirements for fine-grained tasks. Multiprocessor platforms for real-time geospatial applications may limit the time scale to within 10 ms; A grid computing environment may have a time scale that varies from less than 200 seconds to around 3000 seconds for scientific geospatial applications. To obtain analytical results, the near real-time geospatial applications is defined as ranging from seconds to minutes, normally up to 5 minutes, based on experience of geospatial applications. However, one skilled in the art will recognize that this timing may change, as computing power and task complexity change. Certain assumptions about the task behaviors and machine environment may also be made that may not conspicuously affect the results.

Machine Environment Assumptions will now be discussed.

(A1) The machines executing the tasks may be uniform parallel machines—i.e. the machines each have a speed sⱼ and the processing time for each task is pᵢⱼ=pᵢ/sⱼ.

(A2) The network connections among all the machines may be peer-to-peer full speed and don't fatally collapse. This means that the network environment may be identical and stable, and the overhead proportional to dataset size.

Task Characteristics Assumptions will now be discussed.

(A3) The due time of tasks may be equal with small variable diversity.

(A4) Tasks may be restricted to FiNeR and have unit time processing requirements.

Some definitions will now be discussed.

Definition 1—Task t in task set Γ(pᵢ, dᵢ, sᵢ) is a fine-grained (FG) task when: (1) The task execution time pᵢ is less than or equal to 3 minutes, (2) Data set Sᵢ is less than 100 MB; and (3) Tasks are independent from each other and denoted by d.

Definition 2—A near real-time (NRT) task t is a task with due time dᵢ less than or equal to 5 minutes.

Definition 3—FiNeR tasks are the intersection of FG and NRT tasks. {t:tεFG∩NRT}

Definition 2 restricts the granularity that can be interpreted as the execution time and data size of tasks; Definition 3 is mainly focused on due time (Dₜ), which denotes the “deadline” requirement. The due time may be “best-effort” guaranteed, where a distribution of response time is acceptable. The dependency between tasks may be difficult to predict because of the temporal unpredictability of the environment. Tasks may be restricted to be independent because most near real-time geospatial applications' datasets and processing can be divided into independent tasks.

Optimality Criteria will now be discussed. Among the many optimality criteria, such a makespan (processing time), lateness, total flow time, and tardiness, due time may be critical in FiNeR applications. lateness: Lᵢ:=Cᵢ−dᵢ may be chosen as the objective function and the optimization is to minimize the L. For a uniform parallel machine environment α=Q and FiNeR applications with task characteristics as pᵢ=1, the above analysis yields an approximation scheduling problem:

Q|pᵢ=1|Lₘₐₓ.

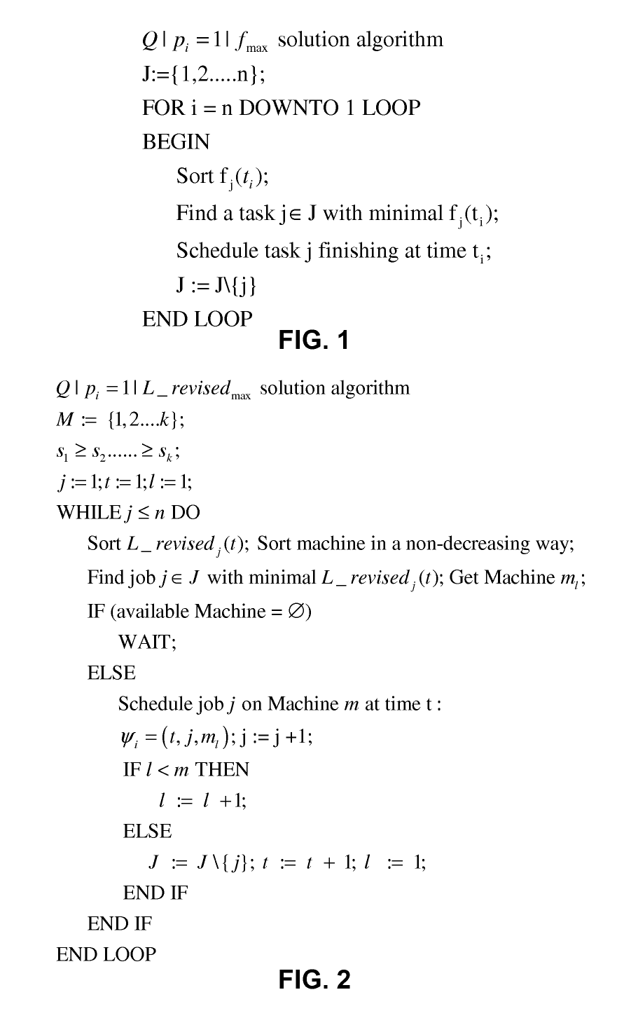

Scheduling algorithms will now be discussed. The FiNeR problem is similar to the general scheduling problem Q|pᵢ=1|fₘₐₓ, where fₘₐₓ is the objective function that is non-decreasing. The general problem could be solved by Lawler's algorithm. (See T A. Varvarigou, V P. Roychowdhury, T. Kallath, E. Lawler, “Scheduling in and out forests in the Presence of Communication Delays,” Transactions on Parallel and Distributed Systems Vol. 7, pp. 1065-1074, 1996). FIG. 1 shows an example of Lawler's Algorithm. The correctness of this algorithm follows the Lawler's algorithm and yields to a complexity of O(n²). For Q|pᵢ=1≡Lₘₐₓ, the objective function is fₘₐₓ=Lₘₐₓ=max{Cᵢ−dᵢ}

When dᵢ is a constant or a variable for FiNeR tasks, Lₘₐₓ will increase with Cᵢ based on the definition Lᵢ:=Cᵢ−dᵢ. Therefore, Lₘₐₓ is a non-decreasing function dependent on Cᵢ. Lawler's algorithm is for scheduling dependent tasks in a bounded number of processor systems. The communication delay may be considered and assumed to be a constant unit. The task dependency may be in the form of Out-forest or In-forest. Independent tasks may be considered as a special case of out-forest with only one root node. Therefore, one may logically adapt the Lawler's algorithm to this case.

The communication time is constant T. With the assumption described within a stable network environment, T may be achieved by designing a communication library with a short message passing mechanism. File transfer time may be in direct proportion with data set Sᵢ over network connection speed SP. So the overhead for each Jᵢ is Oᵢ=Sᵢ/SP+T. This overhead may be added to the finishing time of the corresponding task. The objective function may be reformulated as L_revisedₘₐₓ=max{Cᵢ+Oᵢ−dᵢ}. By matching the smallest objective function value to the first available machine with the fastest speed, the algorithm may be revised as shown in FIG. 2 which shows an example of a revised Lawler's algorithm with fₘₐₓ=Lₘₐₓ=max{Cᵢ−dᵢ}.

Machines may be sorted by decreasing speed to have the fastest machine available first in the queue. Meanwhile, the tasks may be sorted according to revised objective function values in an increasing order. An available machine with the highest speed may be picked and assigned a task with the smallest cost function value. The scheduled task may be deleted from the queue. The inner loop assigns the task to the machine in a circular manner. After all tasks are scheduled, the system may halt and wait for new tasks. This algorithm works similarly to the global earliest-deadline-first algorithm, which can ensure the bounded deadline lateness. (See J. M. Calandrino, J. H. Anderson and D. P. Baumberger, “A Hybrid Real-Time Scheduling Approach for Large-Scale Multicore Platforms,” Proceedings of the 19th Euromicro Conference on Real-Time Systems, Pisa, Italy, 2007, pp: 247-258). However, this embodiment of the present invention uses the cost function and considers more parameters instead of just the task deadlines.

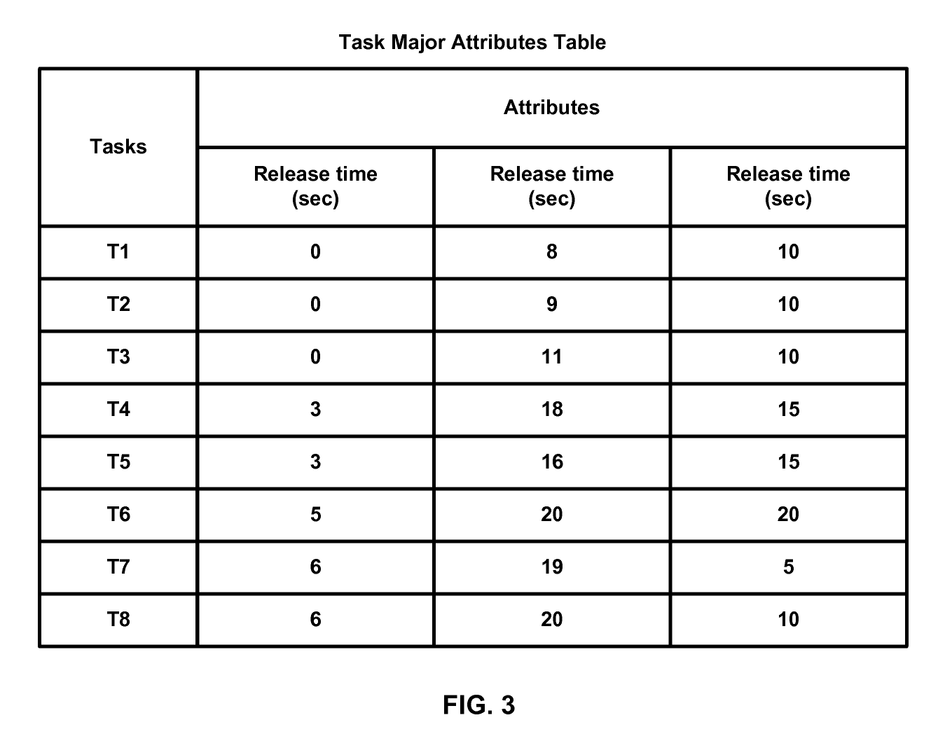

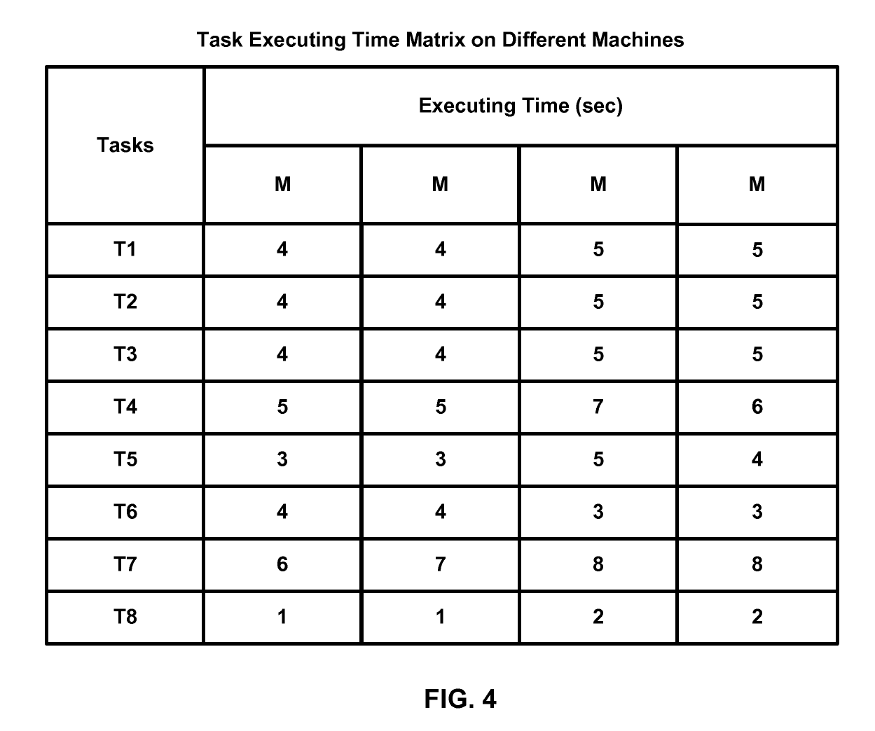

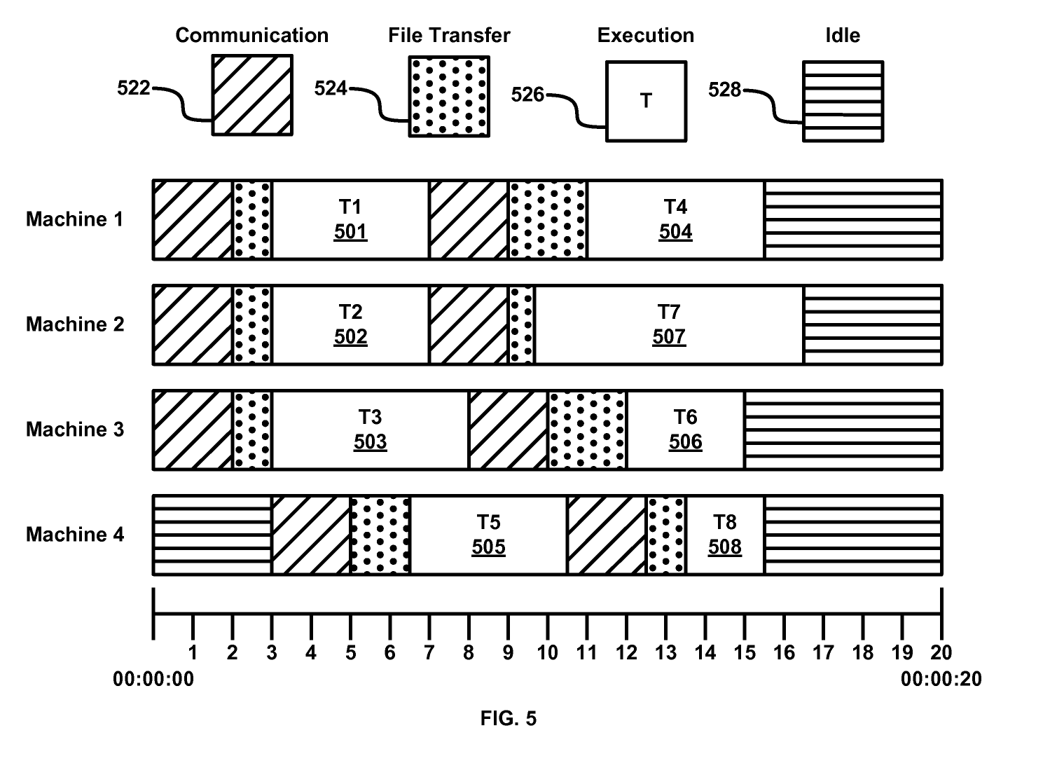

Table 1 (shown in FIG. 3) shows the task major characteristics and Table 2 (shown in FIG. 4) shows the processing speed matrix. FIG. 5 depicts the scheduling of eight example tasks (501, 502, 503, 504, 505, 506 and 507) on a 4-core system. There is no task migration because the overhead associated is unacceptable compared to the task size. The file transfer time(s) 524 are calculated through dividing dataset size by network speed (assumed here to be 10 MB/sec). The communication and scheduling overhead time 522 is assumed to be 2 seconds.

This example finished all the tasks before the deadline. Real geospatial applications are more complicated. For example, the task execution matrix is not easy to define if the user knows little about the tasks. The time complexity is the same as sorting complexity O(n log n). (See P. Brucker, in Scheduling Algorithms (4th ed.), Springer: Berlin Heidelberg, Germany, 2004). And the worst case analysis of this algorithm could be found in “Worst Case Analysis of Lawler's Algorithm for Scheduling Trees with Communication Delays,” by F. Guinand, C. Rapine and D. Trystram in IEEE Transactions on Parallel and Distributed Systems, Vol. 8(10): 1085-1086, 1997, which is

$${ϖ}_{law} ( T , m ) \leq {ϖ}_{opt} ( T , m ) + ⌈ \frac{m - 2}{2} ⌉ .$$

Here ω̅_{law}(T,m) denotes the worst makespan of the Lawler's schedule, while ω̅ₒₚₜ, (T,m) denotes the minimal makespan by feasible schedulers.

A system architecture and implementation of an embodiment of the present invention will now be discussed starting with a discussion of algorithm mapping to the implementation of the embodiment. Based on the extended Lawer's algorithm, resources may be abstracted as components with their own attributes and use a flexible data model to present arbitrary services and constraints on their allocations. A fully structured data model may be used so that the algorithm does not have to invoke any complex expressions to fulfill the match-making. Below is an example resource model describing a virtual machine in an SMP Linux server. The architecture is similar to most middleware, such as Condor.

[
GUID = 1234567890
TYPE = “Computing Node”
IP = “10.1.23.1”
TIME = 23409
RAM = 1048576
DISK = 1048576
STATUS = “BUSY”
CPUFrequency = 1500
OS = “Linux-kernel-2.6.x”
.......
]

System architecture will now be discussed. Because performance is very sensitive to the overhead, a centralized approach may be taken to implement a middleware, namely Dragon, for handling FiNeR tasks. Dragon is the name used for a prototype embodiment of the present invention. This approach uses a stable central manager, which can be achieved in two ways, 1) the increasing stability of new servers, and 2) a redundant central manager as backup.

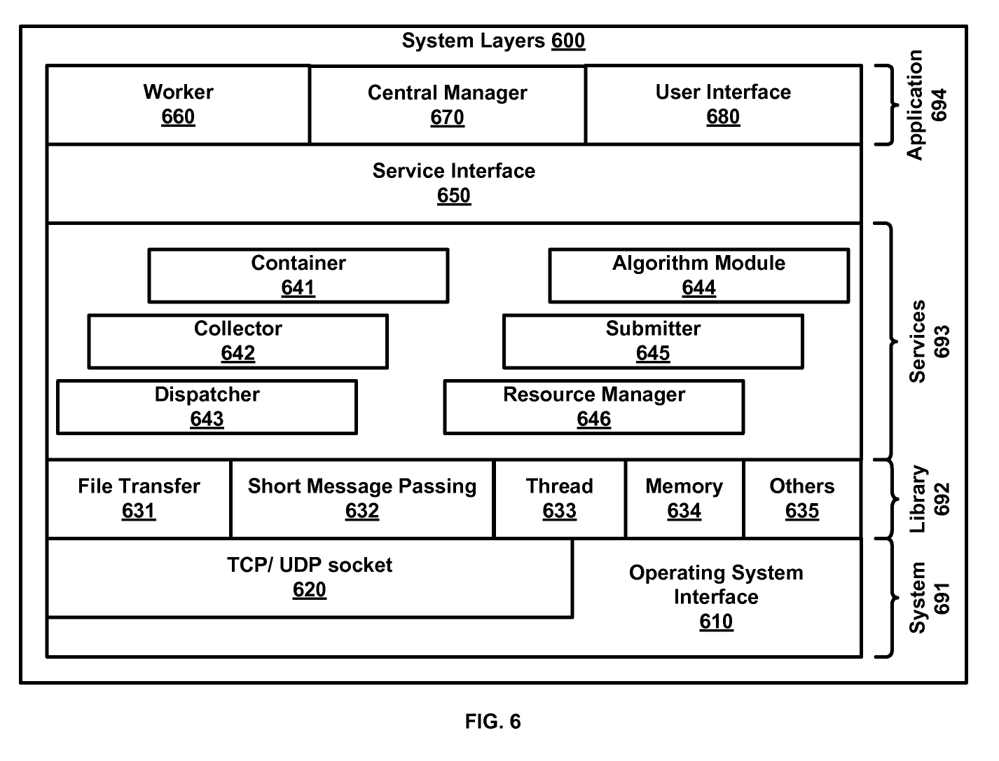

Considering scalability, portability and reusability, a layer structure 600 may be used in the system architecture. As illustrated in FIG. 6 shown, there are four layers: an operating system interface layer 691, a functional libraries layer 692, a services layer 693, and an applications layer 693. They present different levels of transparency to different users from the system designers to the end users. The operating system interface layer 691 provides an identical invoking interface 610 shielding the differences in operating systems communicated to using TCP/UDC socket 620. The library layer 692 provides five types of middleware core functionality including: file transfer 631, short message passing 632, process control 633, memory 634, and miscellaneous 635.

The service layer 693 sits atop the library layer 692, and contains various critical non-GUI system services and performs the work flow. The dispatcher 643 dispatches the tasks from the central coordinator to the executing nodes. The resource manager 646 manages the computing resources, such as CPU, memory, and storage, by reporting their status to the collector 642 immediately when there are any changes. The collector 642 captures and interprets requests from other components. The submitter 645 parses task description files. The services interface 650 is a portal particularly designed to handle web services and other web requests, which makes the services accessible to applications on the Application layer 694 via protocols such as web protocols like HTTP. Examples of applications include worker application(s) 660, central management application(s) 670 and use interface application(s) 680. The algorithm scheduling module 644 is a core element and has a configurable interface, and may work with two priority queues (task queue and node queue) to generate task assignments and send to the dispatcher 643.

Similar to the computer network architecture, the layered structure makes it expandable, reusable and scalable. For example, one may add more modules to the Library to support more functionality.

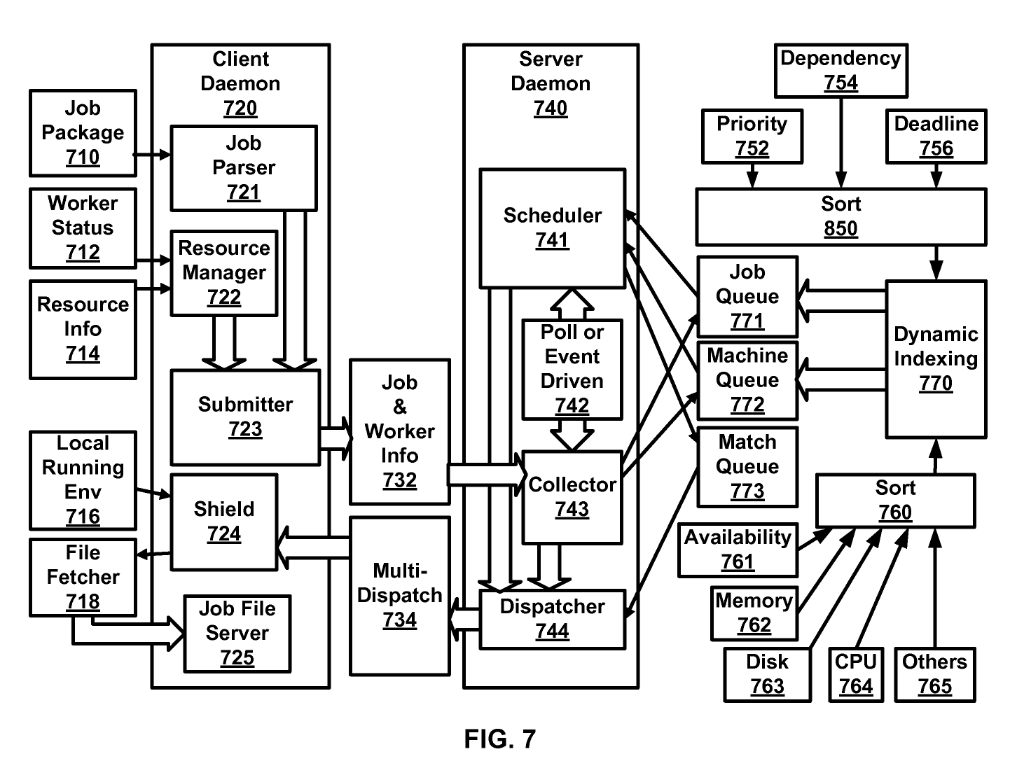

Functionalities and Workflow will now be discussed. FIG. 7 illustrates system functionalities and workflow. In this example, there are two daemons 720 and 740 running on the central manager and executing nodes separately. The server daemon 720 contains the scheduling algorithm 741, runs the control logic 742, and collects the status information 743. The scheduler 741 interacts with the job queue 771, the machine queue 772 a match queue 773 and the collector 743 (through poll or event driven logic 742) to schedule tasks among processing nodes controlled by client daemon(s) 720. The scheduled tasks are forwarded to the dispatcher 744 who dispatches the jobs to the client daemon(s) 720. A dynamic indexing mechanism inputs sorted task data to the job queue 771 and the machine queue 772. The sorted data includes task data and resource data. The task data includes priority data 752, dependency data 754 and deadline data 756 and is sorted by sorting mechanism 850. The resource data includes availability data 761, memory data 762, disk data 763, CPU data 764, and miscellaneous data 765 and is sorted by sorting mechanism 760.

The Client Daemon 720 includes a job parser 721 a resource manager 722, a submitter 723, a shield 724 and a job file server 725. The job parser inputs job package(s) 710 and passes them to submitter 723. The resource manager 722 inputs worker status 712 and resource information 714 to determine available resources which it passes to the submitter 723. The submitter 723 submit's the job and worker information 732 to the collector 743. The shield 724 inputs multi-dispatch 734 information from the dispatcher 744 and determines along with local running environment 716 information for the file fetcher 718 to request from the job file server 725. The

File transfers may be managed to only happen between client daemons 720 to reduce the network load and the risk of failure. The short message passing interface is adopted to reduce the communication overhead.

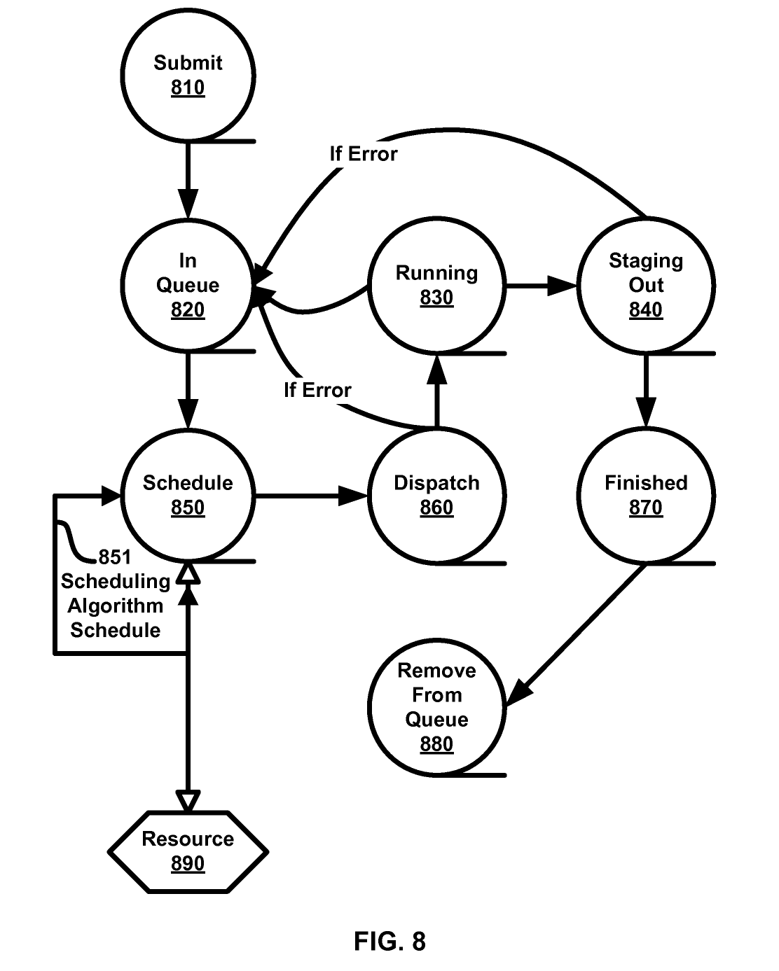

The task has a finite state life cycle transitioning among states until finished or canceled as illustrated in FIG. 8. Jobs may be submitted at 810 to a queue at 820. A scheduling algorithm 851 uses the queue data 820 and resource 890 data to generate a schedule 850. The schedule data is dispatched at 860 to run at 830. The scheduled task stages out at 840 until finished at 870 when it is removed from the queue at 880. Whenever there is an error that stops a job from being processed, the job is fed back to the queue and changed to the least priority.

Performance Evaluations of a prototype embodiment of the present invention will now be discussed starting with a description of the test environment. A test environment was built that leveraged eight distributed servers and several desktops as illustrated in FIG. 9. A central manager 940, configured with 8 cores, 12 GB RAM, and 10 TB of disk space, handles the management from an administrator 910 and access from a user 912. All of the elements are networked through Ethernet 930 as shown. connected through a network with The CPUs have speeds from 2.0 GHz to 3.0 GHz and 38 cores. Specifically, nodes 951, 952, 953 and 954 each have: 4 cores, 2 GB RAM, and 73.4 of GB disk space. Nodes 955 and 956 each have: 8 cores, 4 GB RAM, and 500 GB of disk space. Node 957 has 4 cores, 2 GB RAM, and 67.8 GB of disk space. The whole peak computing performance of the pool 950 is about 100 GFlops. All servers have a 1 Gpbs peer-to-peer high speed Ethernet connection. Also connected to the test set up are several PC's 920, shown as 922, 924 and 926.

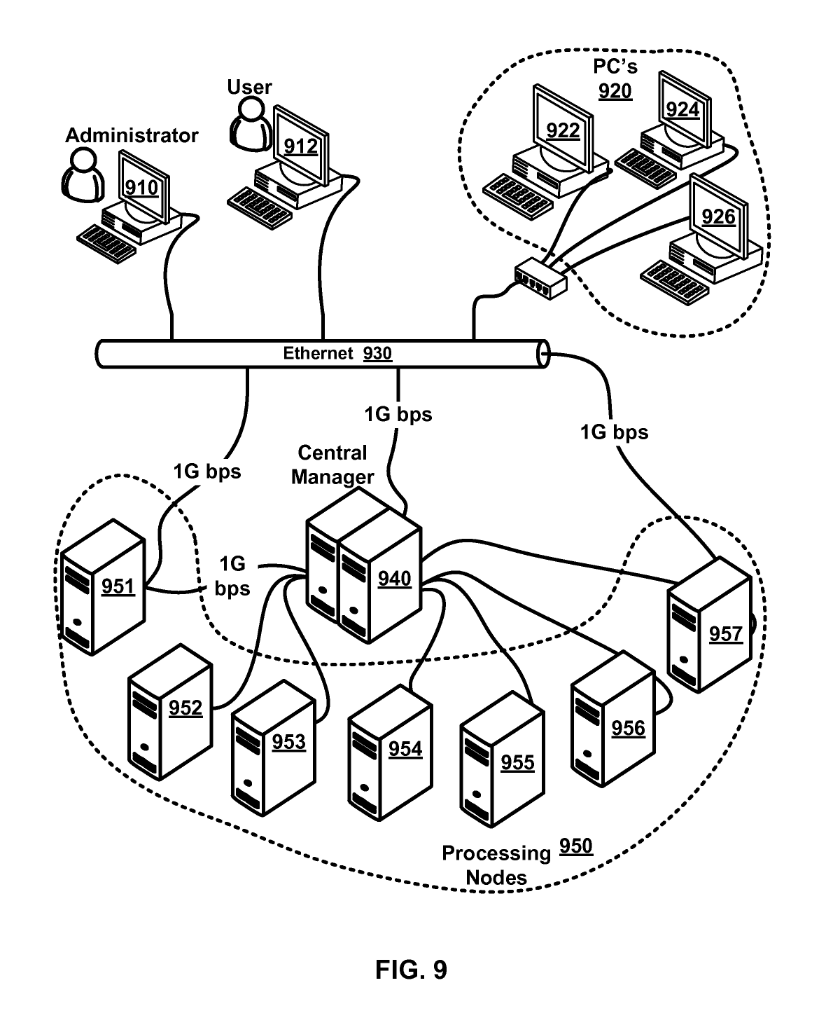

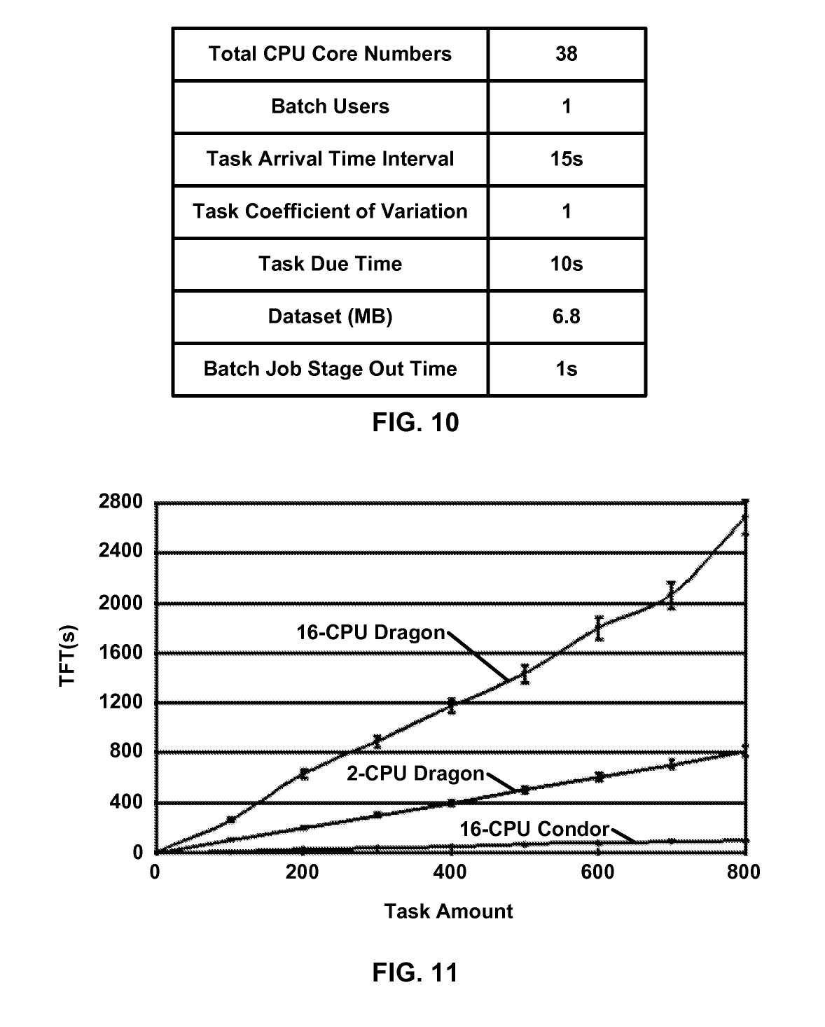

Experimental Results and Evaluations will now be discussed. The middleware developed was evaluated against the Condor middleware with two applications a) the bubble sort algorithm with a time complexity of O(n²) and b) a near real-time routing application that is popular in most geospatial rapid response systems. The task arrival follows an exponential distribution with the parameters listed in table in FIG. 10.

According to the characteristics of FiNeR tasks, several experiments were designed to evaluate the scheduler's performance using the parameters of total finishing time (TFT), task amount, and average response time (ART) with the following relationships:

$$ResponseTime ( i ) = T\_submit - T\_finishing ( i )$$

$$T F T = {\sum }_{i} ResponseTime ( i )$$

$$A R T = T F T / task\_amount$$

Tests were performed on Dragon and Condor in the same environment. Every experiment was repeated several times to eliminate random errors.

Sensitivity to task amount will now be discussed. The task amount experimentation uses tasks with 1.5 seconds finishing times (tested with 2.6 GHz Xeon CPUs on an average) and 6.8 MB datasets. They share the same due time of 10 seconds. FIG. 11 shows the results of Condor (16 CPUs) and Dragon (2 CPUs and 16 CPUs). With the task amount increases, the TFT for both schedulers increase. However, the TFT of the 16-CPU Condor system increases much faster than 16-CPU Dragon. Even the 2-CPU Dragon performs better than the 16-CPU Condor. The better performance of Dragon is because it uses shorter messages to reduce communication cost and the optimized scheduling algorithm leads to a smaller scheduling cost.

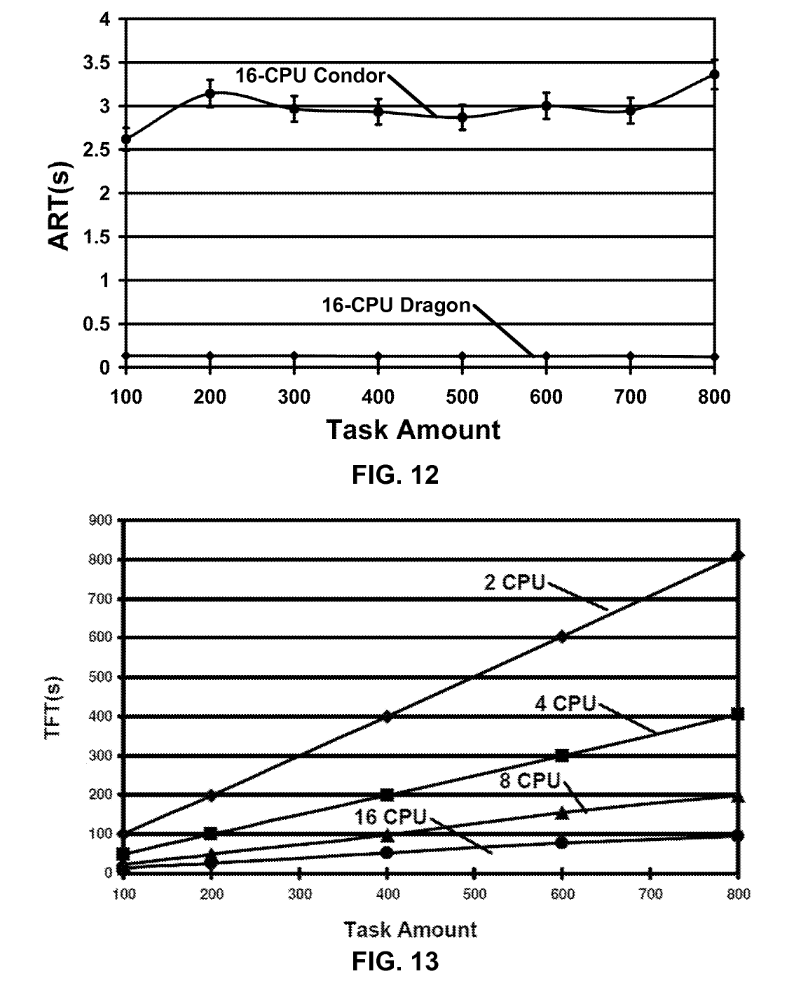

FIG. 12 shows that the ART remains steady when the task amount increases for both middleware. Due to smaller communication and scheduling overhead, the Dragon can get much smaller ART on a 16-CPU platform compared to Condor, which keeps a bigger ART.

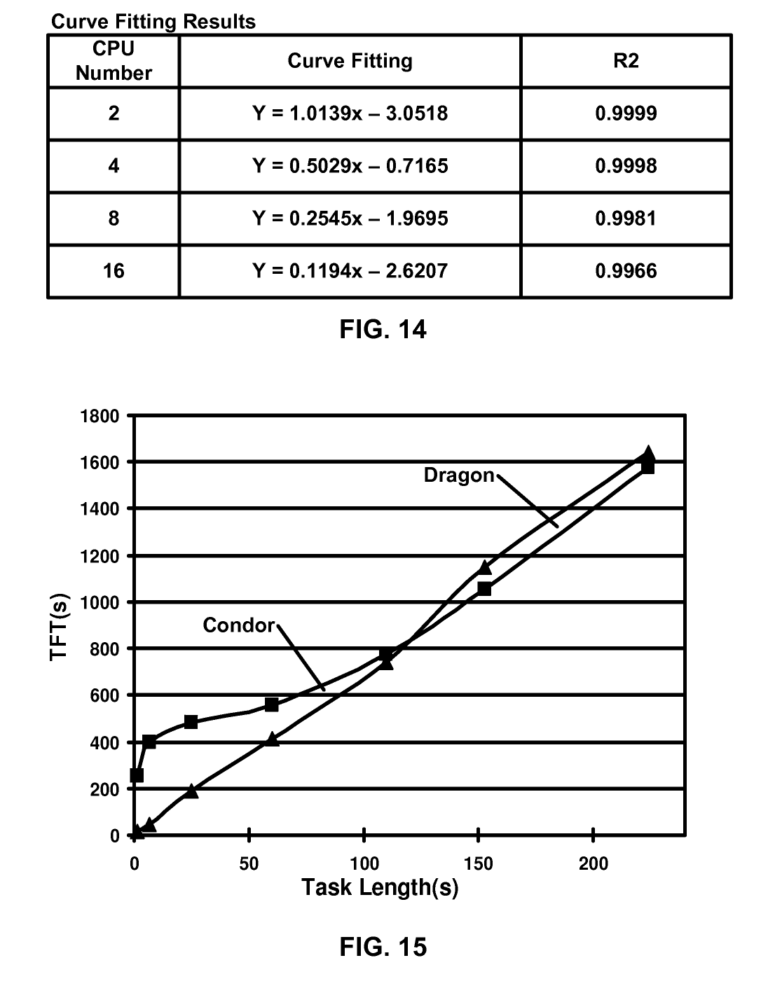

To test the stability of Dragon, the grid platform was also tested with different numbers of CPUs. As illustrated in FIG. 13, when the number of CPUs increases, the TFT decreases because it is easier for the FiNeR tasks to finish when there is more computing power. For the four grid platforms with different numbers of CPUs, the TFT keeps good linearity to task amount as depicted in the table in FIG. 14, where the fitting curves are generated from regression analysis. The closeness to fit (R2) is close to 1, which confirms the low overhead increasing rate of Dragon.

Sensitivity to task length will now be discussed. To find the adaptability of Dragon, the impact of different task lengths on TFT was tested. A constant task amount of 100 and a constant CPU number of 16 was kept. The task length was chosen from between 1.5 to 224 seconds (conforming to the FiNeR definition). Results in FIG. 15 demonstrate that when the task length is less than 120 seconds, Dragon achieves a better performance than Condor. When the task length increases, they perform close to each other. When the task length is more than 125 seconds, Condor performs better than Dragon. The reason is that longer tasks can make the scheduling overhead relatively less significant and the number of communications more significant to performance. This also verifies the definition of the FiNeR boundary definition of execution time.

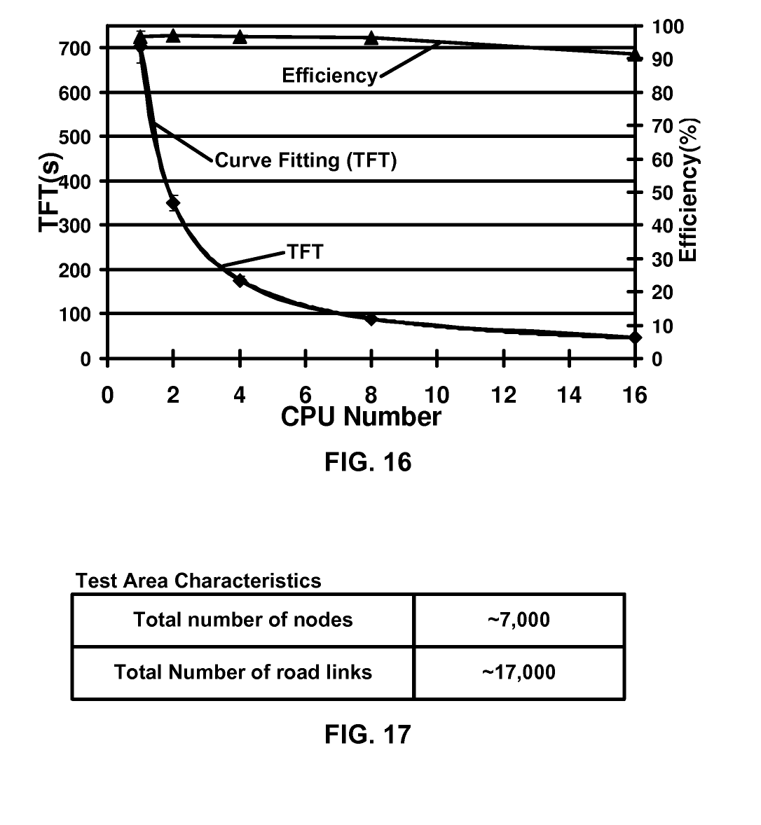

Sensitivity to available CPU number will now be discussed. FIG. 16 illustrates expandability of Dragon with variable numbers of CPUs. The task amount is kept constant at 100 and the task length is 6.8 seconds. The CPU number varies from 2 to 16. FIG. 12 shows a well-fitted curve of TFT to the minus one power of CPU number. The fitting curve is y=694.16x−0.9827 with R2=0.9998. Speedup is used here to measure efficiency, but divided by the CPU number indicating the effective utilization of the CPU computing power. Data in FIG. 16 illustrates that efficiency decreases slightly with the increasing CPU number because of scheduling overhead. But the trend is still the same with more CPUs, so one can achieve better performance.

The experiments demonstrate that Dragon performs better in handling FiNeR tasks as compared to Condor from the tests on different task amounts, different task lengths and available CPU numbers. Therefore, Dragon is better for building computing grid for near real-time applications.

A near real-time routing evaluation will now be discussed. Near real-time routing tries to integrate real-time traffic conditions into routing algorithms and provides the best driving directions for a particular time in a near real-time fashion. A near real-time routing application may be critical for emergency responses, such as evacuating residents from fire zones. An ideal near real-time router needs to respond to innumerable concurrent users with a response time of less than 10 seconds. In this time interval, the routing system has to consider the most current traffic conditions and other factors, such as weather. Dijkstra's shortest path algorithm [Error! Reference source not found.] was chosen and part of the downtown Washington, D.C. metro area as the test area to form a typical FiNeR application.

A concurrent best-path search for 100 users will require hundreds of Giga instruction operations. To satisfy thousands of users' expectations in around 10 seconds is impossible for a single machine. For a grid platform, the middleware will dispatch concurrent user requests to different servers and deliver the results back within the user's expectations.

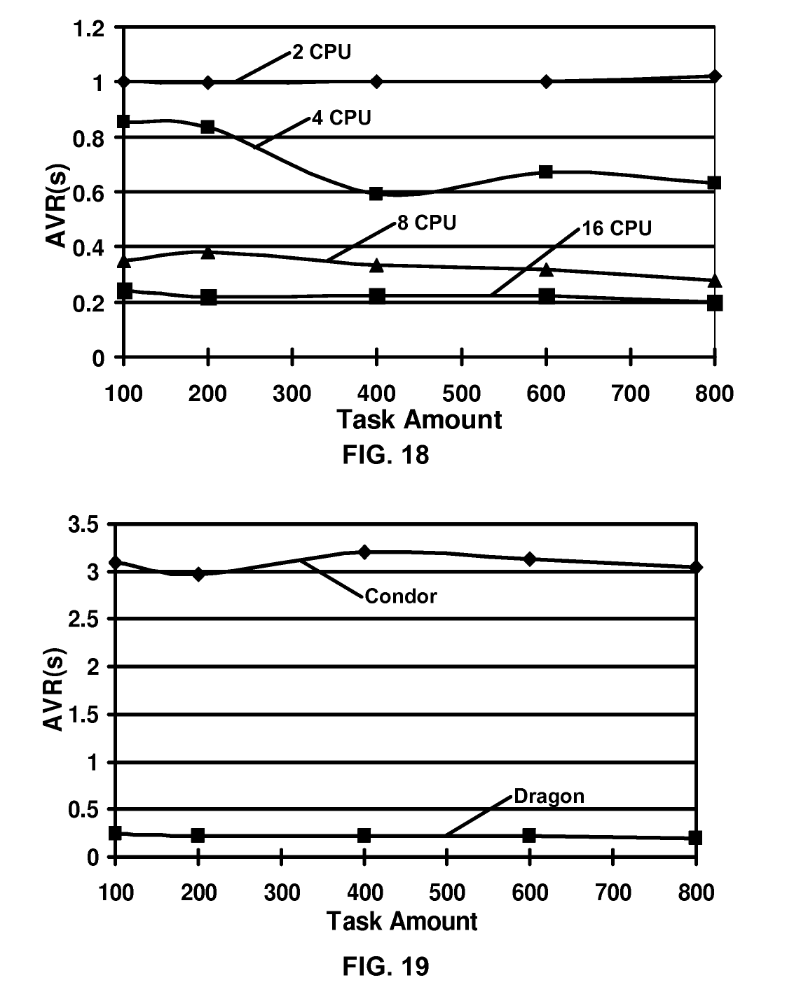

The same tests are repeated for the near real-time routing application. The ART depicted in FIG. 18 illustrates that the more CPUs utilized, the shorter the ART one will get. FIG. 19 depicts that when 16 CPUs are used, Dragon is about 15 times better than Condor. The test demonstrates that Dragon can handle near real-time routing applications.

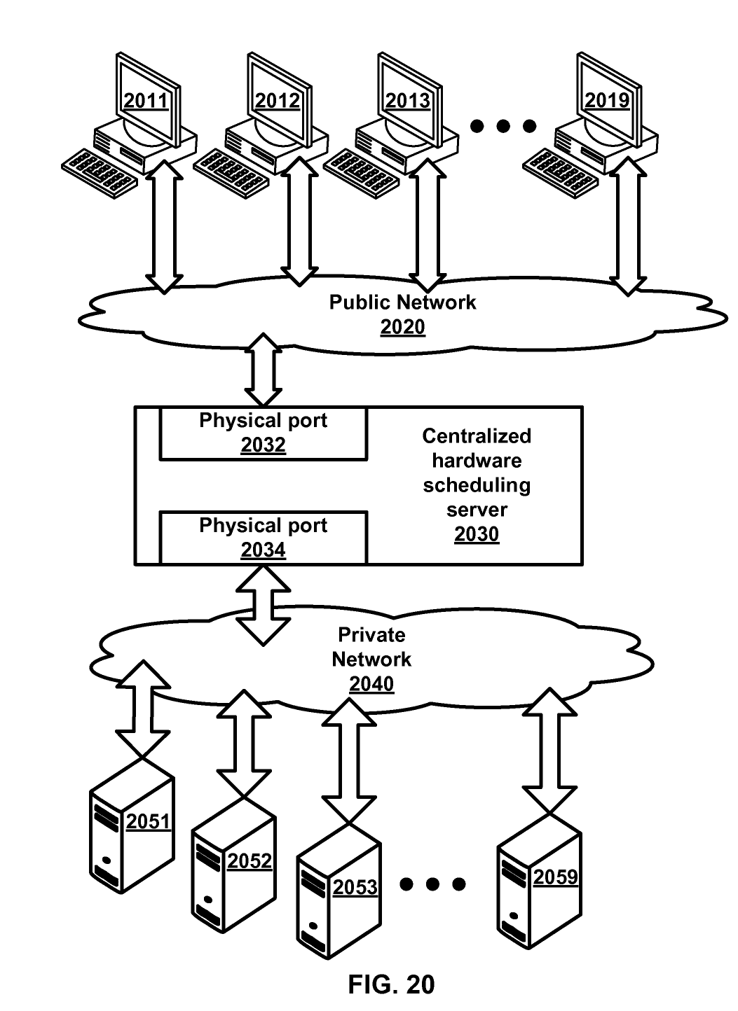

FIG. 20 is a block diagram of a system for scheduling fine-grained near real-time applications as per an aspect(s) of an embodiment of the present invention. The system comprises user device(s) (2011, 2012, 2013, . . . , 2019), a first computer network 2040, a centralized hardware scheduling server 2030, a second computer network 2020 and processing node(s) (2051, 2052, 2053, . . . , 2059).

The centralized hardware scheduling server 2030 may include first physical port 2034 configured to connect to the first computer network 2040. The first computer network 2040 may be a private network connecting processing node(s) (2051, 2052, 2053, . . . , 2059) to centralized hardware scheduling server 2030. Second physical port 2032 may be configured to connect the centralized hardware scheduling server 2030 to public network 2020. To speed up the communications between the processing node(s) (2051, 2052, 2053, . . . , 2059) and the centralized hardware scheduling server 2030, all of the logical ports on all of processing nodes may be opened and all of the logical ports on the centralized hardware scheduling server connected to the first computer network may be opened. Of course, if all ports may not be open, as large a subset as possible should be kept open.

The centralized hardware scheduling server 2030 may be configured with a multitude of functional layer configurations. The multitude of functional layer configurations may include: an operating system interface layer, applications layer, functional libraries layer, and a services layer.

The operating system interface layer may be configured to operate on the centralized hardware scheduling server 2030. The applications layer may be configured to run a central managing application that includes at least one task. Additionally, the applications layer may be configured to run additional applications.

The functional libraries layer may be configured to operate above the operating system interface layer and provide middleware core functionality. Middleware core functionality enables the specialized centralized hardware scheduling server 2030 to perform at least one of the following functions: (1) transfer files among processing nodes and the centralized hardware scheduling server 2030; (2) pass short messages among processing nodes and the centralized hardware scheduling server 2030; and (3) control processes between at least one processing node and the centralized hardware scheduling server 2030.

The services layer may be configured to operate above the functional libraries layer and may include: non-GUI system service process(es) and work flow process(es). The non-GUI system service process(es) may include, but are not limited to: a container process, a collector process, a resource manager, a submitter process and a dispatcher process. The container process may be configured to make components of the services layer accessible to the central managing application using network protocol(s). The collector process may be configured to capture and interpret requests from the functional libraries layer.

The resource manager process may be configured to manage computer resource(s). The managing of computer resource(s) may include reporting changes in computing resource(s) to the collector process through a node queue. Computer resources may include, but are not limited to, a percentage of allocated CPU time; a percentage of allocated memory space, and a percent of allocated space on a computer readable storage medium.

The submitter process may be configured to: (1) parse task description files received from user devices over the public network into task information; and (2) place the task information into a task queue. The dispatcher process may be configured to dispatch tasks from the task queue to at least one of the at least two processing nodes.

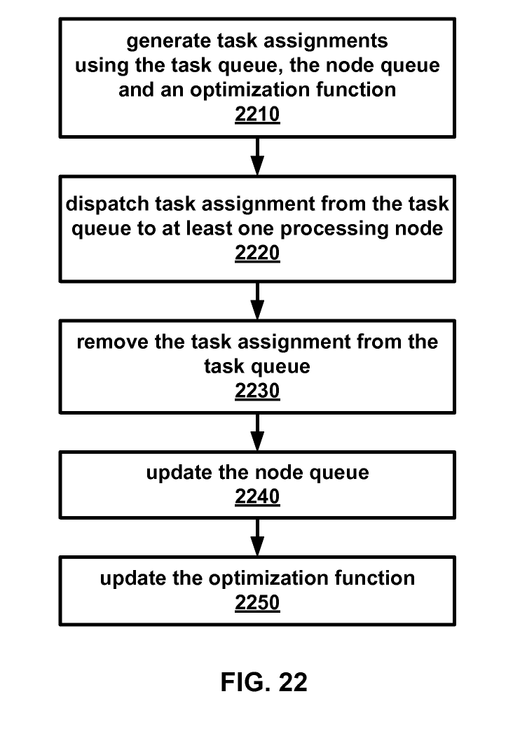

Work flow process(s) may be configured to: run a scheduling algorithm, cause the resource manager to update the node queue and update an optimization function. The optimization function may use an objective function and a smallest cost function. FIG. 22 is a flow diagram of a scheduling process performed by a centralized hardware scheduling server as per an aspect(s) of an embodiment of the present invention. As illustrated in this example, generate task assignments using task queue and the node queue using an optimization function at 2210. At 2220, the dispatcher dispatches task assignment(s) from the task queue to processing node(s). Task assignment(s) may be removed from the task queue at 2230. The resource manager may update the node queue at 2240 and the optimization function updated at 2250. The node queue may be sorted by decreasing processing node speed. Ina addition, the processing nodes with the highest processing node speed may be selected for a task assignment.

Processing node(s) (2051, 2052, 2053, . . . , 2059) are connected to the first computer network 2040. Each of the processing node(s) (2051, 2052, 2053, . . . , 2059) may include, but are not limited to: (1) a processing node physical port configured to connect to the first computer network 2040; (2) a processing node operating system interface layer configured to provide an interface to an operating system running on the processing node; (3) a processing node functional libraries layer; and a processing node services layer.

The processing node functional libraries layer may be configured to: operate above the processing node operating system interface layer; and provide middleware core functionality. The processing node services layer may be configured to operate above the functional libraries layer and may including, but is not limited to: processing node non-GUI system service process(s) and processing node work flow process(s).

The processing node non-GUI system service process(s) may include, but are not limited to: processing node container process configured to make components of the processing node services layer accessible to the central managing application using at least one network protocol; and a processing node collector process configured to capture and report status to the processing node collector process. The processing node work flow process may be configured to execute scheduled task(s).

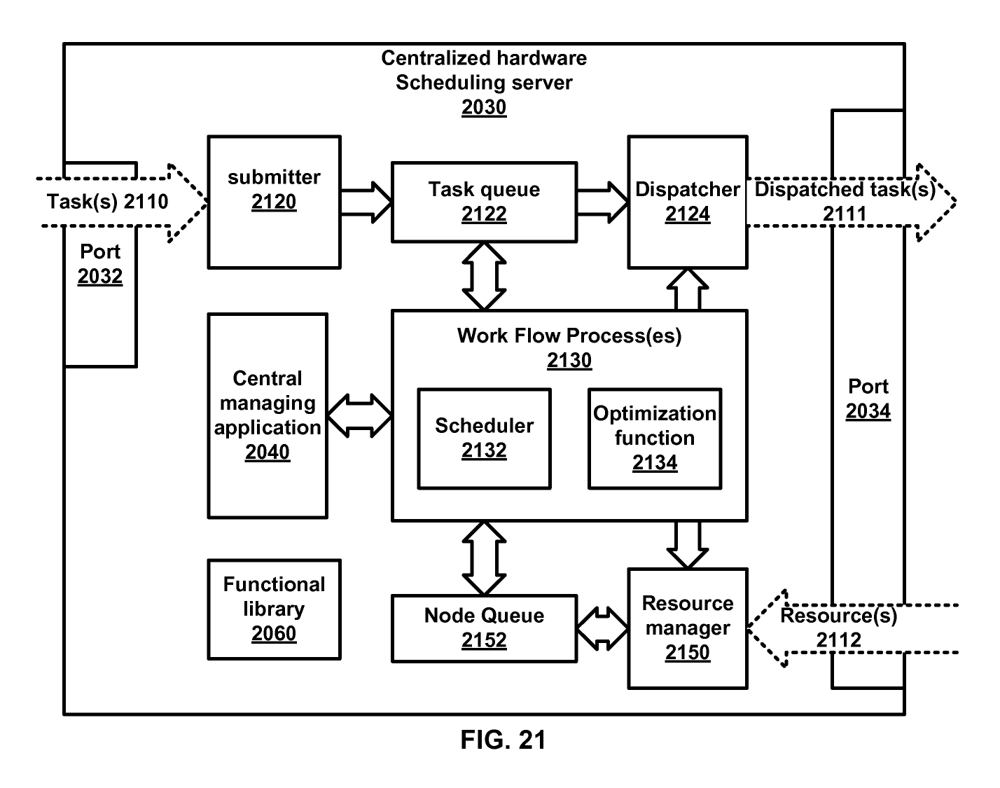

FIG. 21 is a block diagram of a centralized hardware scheduling server 2030 as per an aspect(s) of an embodiment of the present invention. The centralized hardware scheduling server 2030 for scheduling fine-grained near real-time applications may include, but is not limited to: a physical port 2034, physical port 2032, a central managing application 2040, functional library(ies) 2060, and service process(s).

Physical port 2034 may be configured to communicate with processing node(s) through a first computer network. This computer network may be a private network. Each of the processing nodes may include, but are not limited to: at least one processing node functional library configured to provide middleware core functionality; at least one processing node service configured to capture and report processor node status to a central managing application 2040 using middleware core functionality and at least one network protocol, and at least one work flow process configured to execute a scheduled task.

Physical port 2032 may be configured to communicate with at least one user device through a public network. As described earlier, performance may be enhanced by opening all (or as many as possible) of the logical ports on the processing nodes; and on the centralized hardware scheduling server 2030 connected to the first computer network.

The central managing application 2040 may be configured to manage at least one fine-grained near real-time application that includes one or more tasks.

The functional library(ies) 2060 may be configured to provide middleware core functionality. The middleware core functionality may enable the centralized hardware scheduling server 2030 to perform at least one of the following: (1) transfer files among the processing nodes and the centralized hardware scheduling server 2030; (2) pass short messages among the processing nodes and the centralized hardware scheduling server 2030; and/or (3) control processes between the processing nodes and the centralized hardware scheduling server 2030.

The service processes may include, but are not limited to: a resource manager 2150, a submitter 2120, a dispatcher 2124 and at least one work flow process 2130. The resource manager 2150 may be configured to report changes in computing resource(s) 2112 to the node queue 2152. The computer resource(s) 2112 may include, but are not limited to: a percentage of allocated CPU time; a percentage of allocated memory space, and a percent of allocated space on a computer readable storage medium.

The submitter 2120 may be configured to: (1) parse task description file(s) 2110 received from user device(s) into task information; and (2) place the task information into task queue 2122. The dispatcher 2124 may be configured to dispatch tasks 2111 from the task queue 2122 to processing nodes through port 2034.

The work flow process 2130 may be configured to: run a scheduler 2132, cause the resource manager to update the node queue; and update optimization function 2134. The optimization function 2134 may uses an objective function and/or a smallest cost function. The node queue may be sorted by decreasing processing node speed. Similarly, the processing nodes with the highest processing node speed may be positioned on the top of the node queue 2152.

The scheduler 2132 may be configured to generate task assignments using task queue 2122, node queue 2152 and optimization function 2134. Additionally, the scheduler 2132 may cause the dispatcher 2124 to: dispatch task assignment from the task queue 2122 processing node(s); and remove the task assignment from the task queue 2122. The scheduling algorithm may use a revised Lawler's algorithm.

The centralized hardware scheduling server 2030 may further including a container process configured to make service process(s) accessible to the central managing application 2040 using at least one network protocol. Likewise, the centralized hardware scheduling server 2030 may further include a collector process configured to capture and interpret requests from functional library(ies) 2060.

The centralized hardware scheduling server 2030 may go into a wait-for-new-tasks mode after all tasks are scheduled.

Some conclusions will now be discussed. To address the computing scheduling problems in geospatial rapid response research, the FiNeR problem was addressed. Specifically, embodiments of the present invention focuses on the problem of high throughput of FiNeR tasks by 1) utilizing a FiNeR scheduling algorithm to achieve high throughput of FiNeR tasks within a distributed computing environment; and 2) utilizing a middleware, namely Dragon, to provide an optimal solution where small scheduling overhead is achieved for handling FiNeR tasks. The popular bubble sorting task and near real-time routing applications were used to test Dragon in a systematic manner in comparison to Condor. The results show that Dragon can handle FiNeR tasks better than Condor.

The disclosed embodiments add to the knowledge of computer science advancement to geospatial research in handling rapid response applications. Besides geospatial applications as mentioned throughout this disclosure, FiNeR tasks also widely exist within other applications, such as Short term stock analysis involving thousands of stocks predictions that must be processed within several seconds for quick responses to market activities as well as in medical imaging analyses involving requests for disease identification results in minutes. One skilled in the art should be able to use the disclosed embodiments to handle such FiNeR application tasks. It is anticipated that other scheduling algorithms may be used to handle different types of FiNeR tasks.

In this specification, “a” and “an” and similar phrases are to be interpreted as “at least one” and “one or more.”

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) geospatial applications. However, one skilled in the art will recognize that embodiments of the invention could be used for other FiNeR tasks that exist within other applications, such as Short term stock analysis involving thousands of stocks predictions that must be processed within several seconds for quick responses to market activities as well as in medical imaging analyses involving requests for disease identification results in minutes.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A system for scheduling fine-grained near real-time applications comprising:
a) a first computer network;
b) a centralized hardware scheduling server, the centralized hardware scheduling server including:
i) a first physical port configured to connect to the first computer network;
ii) a second physical port configured to connect to a public network;
iii) a multitude of functional layer configurations, the multitude of functional layer configurations including:
(1) an operating system interface layer configured to operate on the centralized hardware scheduling server;
(2) an applications layer configured to run a central managing application that includes at least one task;
(3) a functional libraries layer configured to operate above the operating system interface layer and to provide middleware core functionality, the middleware core functionality enabling the centralized hardware scheduling server to perform at least one of the following:
(a) transfer files among processing nodes and the centralized hardware scheduling server;
(b) pass short messages among processing nodes and the centralized hardware scheduling server;
(c) control processes between at least one processing node and the centralized hardware scheduling server;
(4) a services layer configured to operate above the functional libraries layer, the services layer including:
(a) at least one non-GUI system service process, the at least one non-GUI system service process including:
(i) a container process configured to make components of the services layer accessible to the central managing application using at least one network protocol;
(ii) a collector process configured to capture and interpret requests from the functional libraries layer;
(iii) a resource manager process configured to manage at least one computer resource, the managing including reporting changes in at least one of the at least one computing resource to the collector process through a node queue, at least one of the at least one computer resources including at least one of the following:
1. a percentage of allocated CPU time;
2. a percentage of allocated memory space, and
3. a percent of allocated space on a computer readable storage medium;
(iv) a submitter process configured to:
1. parse task description files into task information, the task description files received from a client over the public network; and
2. place the task information into a task queue; and
(v) a dispatcher process configured to dispatch tasks from the task queue to at least one of the at least two processing nodes;
(b) at least one work flow process, the at least one work flow process configured to:
(i) run a scheduling algorithm, the scheduling algorithm configured to:
1. generate at least one task assignment using the task queue, the node queue, and an optimization function; and cause the dispatcher to:
a. dispatch at least one of the at least one task assignment from the task queue to at least one processing node; and
b. remove at least one of the at least one task assignment from the task queue;
(ii) cause the resource manager to update the node queue; and
(iii) update the optimization function; and
c) the at least two processing nodes, each of the at least two processing nodes connected to the first computer network, each of the at least two processing nodes including:
i) a processing node physical port configured to connect to the first computer network;
ii) a processing node operating system interface layer configured to provide an interface to an operating system;
iii) a processing node functional libraries layer configured to:
(1) operate above the processing node operating system interface layer; and
(2) to provide middleware core functionality;
iv) a processing node services layer configured to operate above the functional libraries layer, the services layer including:
(1) at least one processing node non-GUI system service process, the at least one processing node non-GUI system service process including:
(a) a processing node container process configured to make components of the processing node services layer accessible to a central managing application using at least one network protocol; and
(b) a processing node collector process configured to capture and report status to the processing node collector process; and
(2) at least one processing node work flow process configured to execute a scheduled task.

2. The system according to claim 1, wherein all of the logical ports on all of the at least two processing nodes are open and all of the logical ports on the centralized hardware scheduling server connected to the first computer network are open.

3. The system according to claim 1, wherein the first computer network is a private network.

4. The system according to claim 1, wherein the node queue is sorted by decreasing processing node speed.

5. The system according to claim 1, wherein the processing nodes with the highest processing node speed are selected.

6. The system according to claim 1, wherein the optimization function uses an objective function and a smallest cost function.

7. The system according to claim 1, wherein the applications layer is configured to run additional applications.

8. A centralized hardware scheduling server for scheduling fine-grained near real-time applications comprising:
a) a first physical port configured to communicate with at least two processing nodes through a first computer network, each of the at least two processing nodes including:
i) at least one processing node functional library configured to provide middleware core functionality;
ii) at least one processing node service configured to capture and report processor node status to a central managing application using middleware core functionality and at least one network protocol;
iii) at least one work flow process configured to execute a scheduled task;
b) a second physical port configured to communicate with at least one user device through a public network;
c) a central managing application configured to manage at least one fine-grained near real-time application, at least one the at least one fine-grained near real-time application including at least one task;
d) at least one functional library configured to provide middleware core functionality, and
e) at least one service process, the at least one service process including:
i) a resource manager configured to report changes in at least one computing resource to a node queue, at least one of the at least one computer resources including at least one of the following:
(1) a percentage of allocated CPU time;
(2) a percentage of allocated memory space, and
(3) a percent of allocated space on a computer readable storage medium;
ii) a submitter configured to:
(1) parse at least one task description file received from at least one of the at least one user device into task information; and
(2) place the task information into a task queue; and
iii) a dispatcher configured to dispatch tasks from the task queue to at least one of the at least two processing nodes; and
iv) at least one work flow process configured to:
(1) run a scheduling algorithm, the scheduling algorithm configured to:
(a) generate task assignments using task queue, the node queue and an optimization function; and
(b) cause the dispatcher to:
(i) dispatch task assignment from the task queue to at least one processing node; and
(ii) remove the task assignment from the task queue;
(2) cause the resource manager to update the node queue; and
(3) update the optimization function.

9. The centralized hardware scheduling server according to claim 8, further including a container process configured to make at least one of the at least one service process accessible to the central managing application using at least one network protocol.

10. The centralized hardware scheduling server according to claim 8, further including a collector process configured to capture and interpret requests from at least one of the at least one functional library.

11. The centralized hardware scheduling server according to claim 8, wherein the middleware core functionality enables the centralized hardware scheduling server to perform at least one of the following:
a) transfer files among the at least two processing nodes and the centralized hardware scheduling server;
b) pass short messages among the at least two processing nodes and the centralized hardware scheduling server; or
c) control processes between the at least two processing nodes and the centralized hardware scheduling server.

12. The centralized hardware scheduling server according to claim 8, wherein:
a) all of the logical ports on the at least two processing nodes are open; and
b) all of the logical ports on the centralized hardware scheduling server connected to the first computer network are open.

13. The centralized hardware scheduling server according to claim 8, wherein the first computer network is a private network.

14. The centralized hardware scheduling server according to claim 8, wherein the node queue is sorted by decreasing processing node speed.

15. The centralized hardware scheduling server according to claim 8, wherein processing nodes with the highest processing node speed are positioned on the top of the node queue.

16. The centralized hardware scheduling server according to claim 8, wherein the optimization function uses an objective function and a smallest cost function.

17. The centralized hardware scheduling server according to claim 8, wherein the optimization function uses an objective function.

18. The centralized hardware scheduling server according to claim 8, wherein the optimization function uses a smallest cost function.

19. The centralized hardware scheduling server according to claim 14, wherein the centralized hardware scheduling server goes into a wait-for-new-tasks mode after all tasks are scheduled.

20. The centralized hardware scheduling server according to claim 8, wherein the scheduling algorithm uses a revised Lawler's algorithm.
